(19) United States
(12) Patent Application Publication
(10) Pub. No.: US 2006/0208199 A1
(43) Pub. Date: Sep. 21, 2006

(54) Luminescent calibration

(75) Inventors: Sean Gallagher, Claremont, CA (US); Soham Mehta, Upland, CA (US)

Correspondence Address: GARY F. WITTING, 5834 EAST OAK STREET, SCOTTSDALE, AZ, 85257, US

(73) Assignee: UVP Inc.

(21) Appl. No.: 11/083,768

(22) Filed: Mar. 18, 2005

(51) Int. Cl. G01J 1/58

(52) U.S. Cl. 250/458.1

(57) ABSTRACT

A luminescent calibration device (108) is provided with the luminescent calibration device (108) having a housing (202) with a surface (228). The housing (202) has a length (210), a width (214), and a thickness (212). The housing (202) having a luminescent standard (204) disposed on the housing (202). A method for calibrating and normalizing luminescent data across a sample and to normalize data from day to day variations is provided.

### FIELD OF INVENTION

This invention relates in general to calibration techniques, and more particularly, to calibration techniques using a luminescent calibration device.

### BACKGROUND

At present, conventional calibration of optical systems and their target samples can not be done with sufficient accuracy. Typically, in a conventional optical system, calibration of the optical system means determining the lowest or smallest amount of luminescent radiation that can be detected. In the prior art, this is achieved by emitting luminescent radiation and changing an aperture size or limiting the amount of luminescent light that is seen by the detector. When the smallest amount of light is detected, the optical system is considered calibrated. However, while this kind of calibration provides useful information as to sensitivity of the optical system, it does not provide calibration solutions to many different kinds of problems that would make the calibration of the optical system more useful and data sensitive relative to a biologic sample.

For instance, conventional calibration does not address problems of day-to-day variation of an optical system or variations in the biologic sample. These day-to-day variations have a large number of causes and can have profound effects on the interpretation of data. One source of variation can be in the detection system or the optical system where the environment can change the way the detection system performs. For example, changes in environmental conditions such as, but not limited to, humidity, temperature, or the like from day-to-day can change the performance of the detection system. Additionally, environmental changes can also change the performance of the biological sample. Thus, affecting the ability of being able to correlate or compare one set of data to another set of data.

In another example of a problem, day-to-day variations in voltage from power supplies that provide power to both the detection system and a radiation emitting system can affect both the detection system and the emitting system, and thus provide variation in the data that is taken and analyzed. Moreover, it should be noted that because of these day-to-day variations, the data that is collected has an inherent uncertainty and variation in it that may skew and affect the analysis of the collected data.

In yet another example of a problem, day-to-day degradation over time of the optical detection system and the light emitting system can not be taken into account with the present state of the art. Additionally, comparison of an earlier data set to a later data can not be accurately achieved. In both the light emitting system and the optical detection system, there are many causes of degradation such as, but not limited to, chemical and physical fatigue of the emitting source and detection system, diffusion of unwanted gases into the emitting chamber and the detection materials, and the like. Since these changes occur gradually over time, the changes are not noticed and are not corrected. This leads to inaccurate data acquisition and interpretation of the collected data. Moreover, comparing the data over time is extremely difficult, if not impossible, to do in some meaningful way.

It can be readily seen that conventional calibration techniques and optical systems have several disadvantages and problems. These problems and disadvantages do not allow for sufficient precision and full utilization of all the data. Therefore a calibration system for reducing variation in the optical system and data would be highly desirable.

The foregoing general description and the following detailed description are exemplary and explanatory only and are not restrictive of the invention, as defined in the appended claims.

### SUMMARY OF THE INVENTION

A method for normalizing variability in an optical system is described wherein a luminescent standard and a luminescent experimental sample are provided. The luminescent standard and luminescent experimental sample are illuminated with a light. The luminescent light is collected and analyzed, with the luminescent light from the luminescent standard given a first value and stored and the luminescent light from the luminescent experimental sample given a second value and stored. A second luminescent experimental sample and the same luminescent standard are illuminated with a light. The light is absorbed by the same luminescent standard and the luminescent second experimental sample and re-emitted as luminescent light. The luminescent light is collected and analyzed, with the luminescent light from the same luminescent standard given a third value and stored and the luminescent light from the luminescent second experimental sample given a fourth value and stored. The values are normalized by establishing a relationship between the first value from the luminescent standard and the third value of the same luminescent standard, thus generating a correction factor. The correction factor is used to normalize the fourth value to the second value of the first luminescent sample.

It is another aspect of the invention, to provide a luminescent calibration device. The luminescent calibration device includes a housing having a length, width, and thickness with a luminescent standard being disposed on or in the housing.

It is another aspect of the invention, to provide a luminescent calibration device integrated into an experimental sample.

It is another aspect of the invention, to be able to normalize data over multiple experiments.

It is another aspect of the invention, to remove day-to-day variability from the processing and interpretation of optical data.

It is another aspect of the invention, to provide a non-varying luminescent standard.

It is another aspect of the invention to relate experimental results across time.

The foregoing general description and the following detailed description are exemplary and explanatory only and are not restrictive of the invention, as defined in the appended claims.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 is a greatly simplified illustrated view of an optical reading system;

FIG. 2 is a greatly simplified illustrated perspective view of a luminescent calibration device;

FIG. 3 is a greatly simplified sectional view of a luminescent calibration device;

FIGS. 4 and 5 are simplified illustrations of electrophoresis gel samples with a luminescent calibration device;

FIG. 6 is a greatly simplified illustration of a micro-well plate: and

FIG. 7 is a greatly simplified diagrammatic illustration of a process flow chart.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms front, back, top, bottom, over, under, and the like in the description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF THE DRAWINGS

The following descriptions are of exemplary embodiments of the invention and the inventors' conceptions of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

Before addressing details of the embodiment described below, some terms are clarified.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The term housing is intended to mean a structure that supports a luminescent standard. The housing can be made to any suitable shape and size depending upon the specific application. The housing can range from a simple support on which the luminescent standard is placed to a support that holds the luminescent standard.

Luminescence is intended to mean a process in which energy is emitted from a material at a wavelength or frequency. Thus, luminescence includes fluorescence, phosphorescence, triboluminescence, chemiluminescence, opalescence, thermoluminescence, self-luminescence, radioactive luminescense, electroluminscense, and the like.

Fluorescence is intended to mean a process in which a material absorbs energy at a certain wavelength or frequency and the material emits energy at a longer wavelength or frequency.

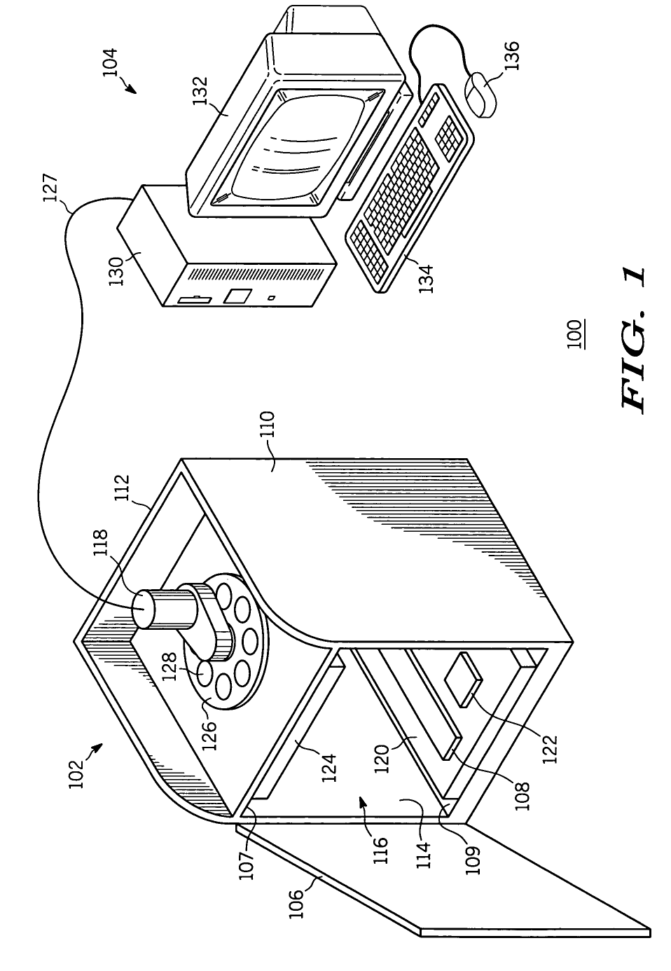

FIG. 1 is a simplified illustrated view of an optical reading system 100. The optical reading system 100 includes a dark room enclosure 102 and a data analysis system 104. It should be understood that similar features or elements will retain their original identifying numerals throughout this document. As shown in FIG. 1, dark room enclosure 102 includes a top 107, a bottom 109, sides 110, 112, and 114 forming an interior space 116 having a door 106. With door 106 closed, darkroom enclosure 102 forms an essentially light tight box, i.e., essentially sealing out light from the ambient environment. Door 106 allows placement of a luminescent calibration device 108 and a sample 122 to be placed inside the dark room enclosure 102 for evaluation. Dark room enclosure 102 can be made to be any suitable shape, design, or size. For example only, dark room enclosure 102 can be made small enough to accommodate a single microscopic slide used for biochip devices, micro-fluidic devices, tissue culture plates, electrophoresis gel samples, micro plates, multi-well plates, and the like. Alternatively, dark room enclosure 102 can be made large enough to accommodate larger samples of any size such as, but not limited to, whole laboratory animals, botanical samples, and the like.

As shown in FIG. 1, luminescent calibration device 108 is placed into dark room enclosure 102 along with sample 122. However, it should be understood that luminescent calibration device 108 can be made to any suitable size or configuration depending upon the specific application. For example, when examining sample 122 that is approximately 10.0 centimeters by 10.0 centimeters, luminescent calibration device 108 can be configured to a size that is approximately the same, as sample 122, or sizes that are larger or smaller then sample 122 Alternatively, when sample 122 is a microscopic, luminescent calibration device 108 can be formed to be sized accordingly and/or placed on the microscope slide. Additionally, luminescent calibration device 108 can also be incorporated into sample 122 and be part of sample 122 configuration.

As shown in FIG. 1, a trans-light emitter 120 and an epi-light emitter 124 allow for bottom and top lighting, respectively, of both the luminescent calibration device 108 and sample 122. Trans-light emitter 120 and epi-light emitter 124 are made to provide a uniform light source at a variety of frequencies or wavelengths and intensities. It should be understood that selection of individual frequencies and intensities is application specific and is at the control of the user. By way of example, while any suitable wavelength of light can be used in optical reading system 100, the trans-light and epi-light can be configured to emit light with wavelengths that can range from 171 to 900 nanometers. Additionally, the trans-light and epi-light can be configured to emit light with wavelengths that can range from 300 to 750 nanometers.

Dark room enclosure 102 incorporates an image device 118 with a filter wheel 126 having individual filters with a filter 128 indicated. Image device 118 can be any suitable imaging device such as a charged-coupled device (CCD) camera, a photomultiplier tube (PMT), photodiode, a single photodectector chip, multiple photodetector chips, or the like. Filter 128 can be placed in front of image device 118 to filter or remove unwanted frequencies of light. It should be understood that selection of filter 128 is application specific and in some cases does not need to be used at all. Image device 118 collects photons that are emitted from luminescent calibration device 108 and sample 122. As the photons and/or images are collected by image device 118 and turned into electrical signals, these electrical signals are sent to data analysis system 104 by any suitable manner such as, but not limited to, directly connecting to data analysis system 104, or wirelessly connecting, or the like. As shown in FIG. 1, an electrical cable 127 is used to couple image device 118 to data analysis system 104.

Data analysis system 104 can be any suitable system and accessories that are capable of taking data from image device 118 and manipulating the data in a variety of ways. Typically, data analysis systems 104 use a computer 130. However, it should be understood that other computer systems can be use as well such as main frames, mid frames, a single integrated circuit, or a combination of integrated circuits, or the like. Typically, computer 130 includes a processor, memory such as random access memory (RAM), Read Only Memory (ROM), drive elements such as a hard drive, floppy disc drive, and optical elements such as a Compact Disc drive (CD), a Digital Video Disk (DVD) and the like. Additionally, computer 130 typically has a display 132, a keyboard 134, and a mouse 136. Computer 130 can contain additionally hardware and software, calibration software, and imaging processing logic for processing data from image device 118. While computer 130 with several accessories has been described, it should be understood that specific hardware and software can be modified so as to fit into a module that may contain one or more integrated circuits or the like.

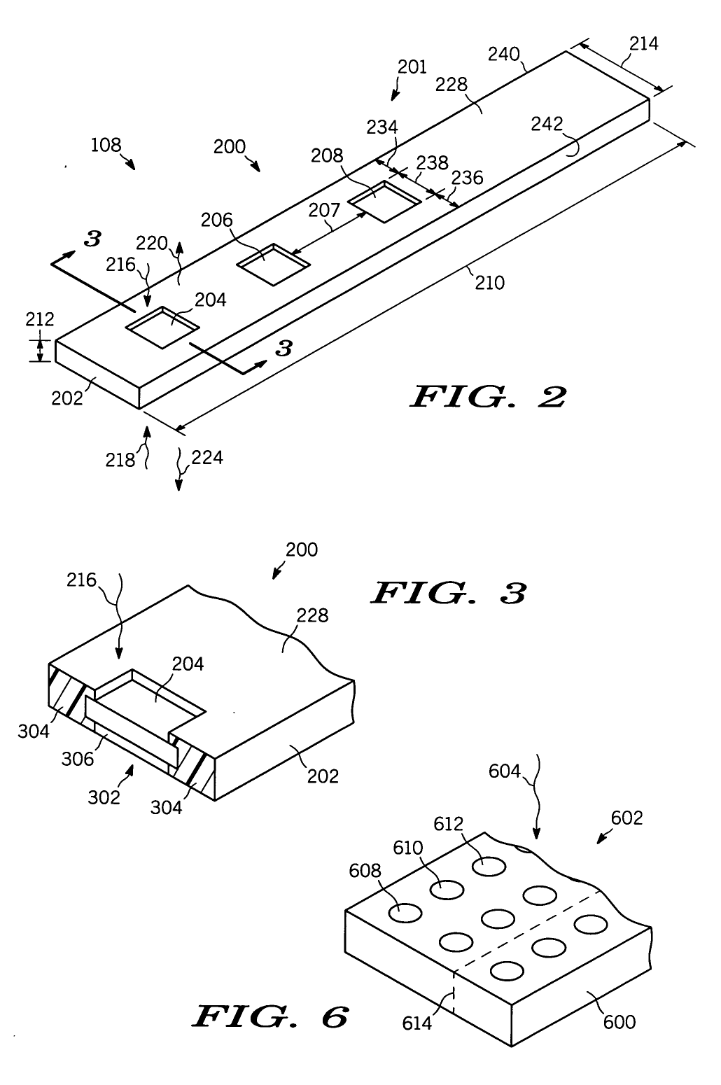

FIG. 2 is a simplified perspective illustration of a luminescent calibration device 108. In this particular embodiment, luminescent calibration device 108 is in the form of a luminescent calibration slide 200 having a plurality of fluorescent standards 201, with luminescent standards 204, 206, and 208 being specifically identified and disposed across a housing 202. While FIG. 2 shows the plurality of fluorescent standards 201, in some instances, use of a single fluorescent standard, such as luminescent standard 208, can be used to achieve calibration and normalization of optical reading system 100.

Housing 202 is made of any suitable material such as, but not limited to, polymer resins or plastics, metal, ceramic, glass, and or the like, and is made by any suitable method or technique such as, but not limited to, molding, cutting, dieing, milling, stamping, or the like. Selection of the materials and manufacturing techniques can provide certain advantages and flexibilities to manufacture and use of luminescent calibration slide 200. By way of example only, use of polymer resins and molding technology can greatly reduce the cost to manufacture and provide several other advantages. For example, housing 202 can be molded with an optically clear resin over luminescent standards 204, 206, and 208, thereby protecting the luminescent standards 204, 206, and 208. Additionally, by adjusting the chemical structure of the resin, an optical filter can be made over luminescent standards 204, 206, and 208. Further, by molding in certain optical structures such as, but not limited to, a lens, a grating, a waveguide, or the like, luminescent calibration slide 200 can be made more useful.

Housing 202 can be made to any suitable size having a length 210, a width 214, and a thickness 212 depending on the specific application. By way of example only, length 210, width 214, and thickness 212 can range widely, with length 210 ranging from 2.0 centimeters to 25.0 centimeter, width 214 ranging from 5.0 millimeters to 5.0 centimeters, and thickness 212 ranging from 5.0 millimeters to 2.0 centimeters. Further, housing 202 can be made to any suitable shape or shapes such as, but not limited to, a rectangle, an oval, a square, circular, or the like.

For example, when working with electrophoresis gels, it may be desirable to have length 210 approximate the length of the electrophoresis gel sample. More specifically, while it should be understood that housing 202 can be any suitable size, several gel sizes have become standard in the art. For example, at present, electrophoresis gels can range from 10 by 10 centimeters to 30 by 30 centimeters. Thus, in some instances, housing 202 can be made to approximate at least one side of the electrophoresis gel. Additionally, it should be understood that housing 202 can be sized to be on the order of microscope slides having an approximate size of 3.5 by 7.2 centimeters or smaller. Thus, housing 202 can be made approximating the size of the microscope slide. Alternatively, it should be understood that luminescent material could be adapted to be microscopic in nature. Thus, the luminescent material could be place directly on a microscope slide. It should be understood that micro-fluidic devices and micro-electrophoresis gels are fully contemplated to be within the scope of the present invention.

Luminescent standards 204, 206, and 208 can be made of any suitable luminescent material such as, but not limited to, luminescent ceramics, phosphors, electroluminescent materials, luminescent glasses, quantum dots, luminescent plastics, or the like. It should be understood that luminescent standards 204, 206, and 208 can be laid out on any suitable substrate that that gives support. Also, when light 216 or 218 has to pass though the substrate and any intervening material, the substrate and the intervening material must be engineered to be able to allow desired wavelengths of light to pass though the substrate and intervening material. The luminescence from these luminescent materials do not appreciably degrade or diminish over time. The luminescent materials can be repeatedly exposed to the same constant energy source, in the form of light with a first wavelength and the luminescent material responds with luminescence at a second wavelength regardless of the number of times the luminescent material is exposed. Additionally, it should be understood that some luminescent material use other forms of energy to produce luminance.

For example, with light 216 having a first wavelength and a first intensity that strikes and is absorbed by luminescent standard 204, luminescent standard 204 emits a light 220 having a second wavelength and a second intensity. When luminescent standard 204 is repeatedly challenged over time with the first wavelength and the first intensity of light 216, luminescent standard 204 emits light 220 have the same wavelength and intensity as the original light 220. Additionally, when luminescent standard 204 is challenged with a second light having the same wavelength and a different intensity, luminescent standard 204 fluoresces with the same wavelength, but with proportional shift in intensity. Hence, luminescent standard 204 is a stable, repeatable, and predictable standard of luminescence.

Luminescent standards 204, 206, and 208 can be made to emit light at any suitable wavelength. Typically, emission can range between, but not limited to, 400 nanometers to 1200 nanometers. In some embodiments of the present invention, with luminescent standard 204 being excited by light 216 and/or 218 from either or both trans or epi positions, wavelengths can have a more narrow range from 172 nanometers to 800 nanometers.

The luminescent material that makes up luminescent standards 204, 206, and 208 can be made into any suitable configuration or medium such as a powder, sheets, or the like. Thus, the luminescent material can be applied, embedded, suspended or formed into any suitable shape or form. The luminescent material can be made into either an opaque or translucent material. The luminescent material can be purchased from Matech located at 31304 Via Colinas, Suite 102, Westlake Village, Calif. 91362. Additionally, other luminescent materials can be purchased from Colliminated Holes Incorporated located at 460 Division Street, Campbell, Calif., 95008, Quantum Dot located at 26118 Research Road, Hayward, Calif., 94545, Evident Technologies located at 216 River Street, New York, 12180, Duke Scientific located at 2463 Faber Place, Palo Alto, Calif., 94303, and Molecular Probes located at 29851 Willow Creek, Eugene, Oreg. 97402.

Luminescent standards 204, 206, and 208 are disposed on housing 202 in any suitable manner such as, but not limited to, adhesion, molding, clamping, or the like. However, it should be understood that in certain embodiments selection of materials for attaching luminescent standards 204, 206, and 208 on housing 202 need to be selected with care. For instance, when light 216 or 218 has to pass thought an adhesive material, the adhesive material must be engineered to be able to allow desired wavelengths of light to pass though the adhesive.

In one embodiment of luminescent calibration slide 200, with housing 202 being opaque, luminescent standard 204 being affixed to surface 228, and with luminescent standard 204 being either opaque or translucent, light 216 coming from the top (EPI position) strikes and is absorbed by luminescent standard 204. Luminescent standard 204 fluoresces and reemits light 220.

However, it should be understood that housing 202 could be transparent for certain applications.

In another embodiment of luminescent calibration slide 200, with housing being opaque, with luminescent standard 204 being affixed to surface 228, and with luminescent standard 204 being translucent, light 216 coming from the top (EPI position) and/or bottom (Trans position), light 218 coming from the bottom (Trans position) strikes and is absorbed by luminescent standard 204. Luminescent standard 204 fluoresces and light 216 and 218 is re-emitted as light 220 and 224.

Placement of luminescent standards 204, 206, and 208 across housing define certain distances and relationships. Using fluorescent standard 208 in an example, distances 234 and 236 are defined as spaces between fluorescent material 208 and edges 240 and 242 of housing 202. By way of example only, with luminescent standard being about 1.0 centimeter square, distances 234 and 236 can be any suitable distance ranging from 0.0 to 3.0 centimeters, or more.

As shown in FIG. 2, distance 207 is a space between any two fluorescent standards, illustrated by luminescent standards 206 and 208. Distance 206 should be at least sufficient so as not to cause excessive cross-talk and merging of images by imaging device 118. While distance 207 may be any suitable distance depending upon the specific conditions, distance 207 may be approximately twice distance 238. By keeping this minimal distance 207, there is a significant reduction of the possibility of bleaching out and merging of an image.

FIG. 3 is greatly simplified illustration of a sectional perspective view taken across 3-3 of FIG. 2 showing luminescent calibration slide 200 having light 216 entering window or opening 302 and luminescent standard 204 being held by portions 304 of housing 202. Windows 302 can be made to any suitable shape such as, but not limited to, rectangular, circular, oval, or the like depending upon the specific application.

As shown in FIG. 3, luminescent standard 204 is recessed below surface 228 of housing 202. By having this recess, luminescent standard 204 is protected from normal wear and tear of everyday use. Additionally, a layer 306 can be placed on luminescent standard 204 to further protect luminescent standard from normal wear and tear of everyday use. It should be understood that more then one layer can be used. Further, layer 306 can be placed anywhere in the optical path, i.e., from the source of light 120 or 124 (trans or epi) to the imaging device 118, which means layer 306 can be placed above or below the luminescent standard 204. Further, layer 306 could be used as a filter e.g., a neutral-density filter, a lens, or the like. Layer 306 can be made of any suitable material depending upon the specific application. In another embodiment, housing 202 is over-molded over the entire luminescent standard 204, thereby encasing and securing luminescent standard 204 and providing protection to luminescent standard 204 of luminescent calibration slide 200.

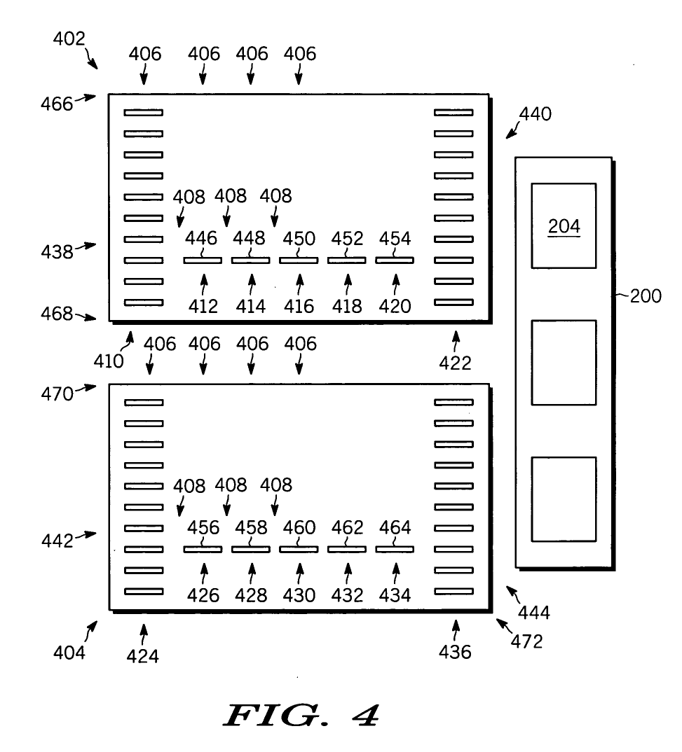

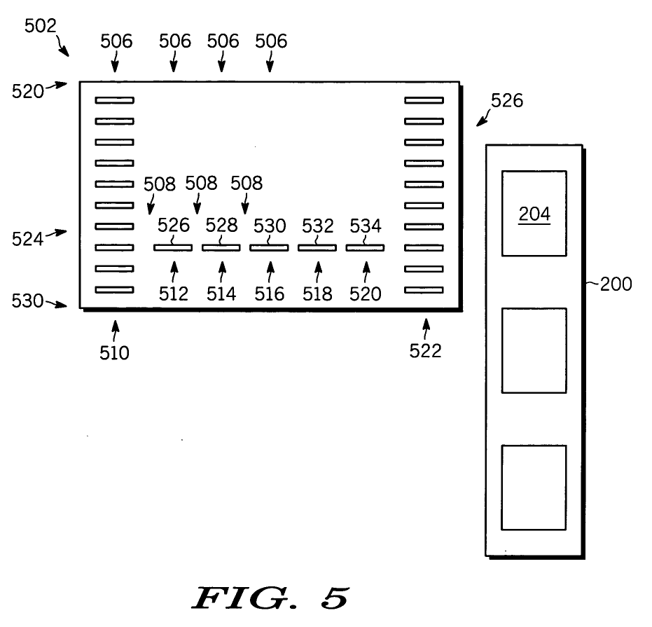

FIGS. 4 and 5 are simplified illustrations of electrophoresis gel samples 402, 404, and 502 with a calibration device 200. Electrophoresis gel samples 402, 404, and 502 are shown having a plurality of lanes or columns 406 and 506 and a plurality of spaces 408 and 508 between the plurality of columns 406 and 506, respectively. For illustrative purposes, columns 410-436 and 510-522 are specifically identified. Columns 410, 422, 424, 436, 510, and 522 show a plurality of bands 438, 440, 442, 444, 524, and 526, respectively. Columns 412-420 and 426-434 show bands 446-454 and 456-464, and columns 512-520 show bands 526-534, respectively.

Electrophoresis gel samples 402, 404, and 502 are made by any suitable manner or technique. Briefly, electrophoresis is a method or technique for separating chemicals or molecules of interest in a sample by charge and mass. Electrophoresis gel samples 402, 404, and 502 are made of any suitable gel material such as, but not limited, colloids materials, polyacrylamide materials, agarose materials, or the like. As shown in FIGS. 4 and 5, electrophoresis gels 402, 404, and 502 are formed into a rectangular sheet having ends 466 and 468, 470 and 472, and 520 and 530, respectively. However, it should be understood that electrophoresis gels can be made in other shapes and sizes can be used such as gel in capillary tubes, circular, or the like.

Sample preparations are made by any suitable well known method in the art such as homogenization, lysis, or the like. Typically, controls having known values including size, weight and fluorescence are prepared and run along with the sample preparations in one or more columns, e.g., the plurality of columns 406 and 506. These controls may provide known quantities of materials or molecular weights that allow analysis of unknown samples. Some sample preparation methods include fluorescent tagging of certain chemicals or molecules so as to enhance detection of the desired chemical or molecule. However, it should be understood that if there is sufficient inherent natural fluorescence of the desired chemical or molecule, tagging with a fluorescent marker may not be necessary. The prepared samples and controls are placed in wells (not shown) on ends 466, 470 and 520 of electrophoresis gel samples 402, 404, and 502. The wells correspond in position to the plurality of columns 410-436 and 510-522. A voltage is applied between ends 466 and 468, 470 and 472, and 520 and 530 which drives the samples and controls though the gel and separates the samples and controls in accordance their size and charge. After a period of time, the chemicals and molecules in the samples and controls have migrated and separated across the electrophoresis gel 402, thereby making bands, e.g., bands 446-454 and the plurality of bands 438 in the electrophoresis gels 402, 404, and 502 having high densities of specific molecules and/or chemicals.

Referring now to FIGS. 1-2 and FIG. 4, electrophoresis gel sample 402 is examined and analyzed using optical reading system 100 where electrophoresis gel sample 402 and luminescent calibration device 200 are exposed to either or to both light 216 and/or 218 in dark room enclosure 102. Exposure of luminescent calibration slide 200 and electrophoresis sample 402 to either light 216 or 218 or both causes certain fluorescent chemicals and molecules that have spread out across the gel in the plurality of columns 406 to fluoresce.

By way of example only, when light 216 strikes luminescent standard 204 and electrophoresis gel sample 402, luminescent standard 204, the plurality of bands 438 and 440, and bands 446-454 of electrophoresis gel sample 402 fluoresce. The fluorescence from luminescent standard 204 and electrophoresis gel sample 402 is captured by image device 118 and turned into pixels. These pixels are digitally processed by a computer software program and stored in computer 130 so as to form an image of luminescent standard 204 and electrophoresis gel sample 402, as well as calculating pixel-volumes for luminescent standard 204 and for each individual fluorescent bands of the plurality of bands 438 and 440 and bands 446-454 and stores these pixel-volumes or pixel-values in the memory of computer 130. A variety of metrics can be used to represent pixel-volume. One method of doing so for a luminescent object is adding gray-levels of all pixels which form that object. In another method, one could represent pixel-volume by taking an average (mean) of the grey levels.

By way of example only, for the sake of simplicity and clarity, concerning only luminescent standard 204 and band 446, pixel-volumes for luminescent standard 204 and band 446 are calculated, stored, represented in a mathematical form and labeled V_{FS1} and V_{S1}, respectively. It should be understood that each individual band of the plurality of bands 438 and 440 and bands 446-454 would each receive individual values and be labeled and stored. Also, by storing the images and the pixel-volumes of luminescent standard 204, the plurality of bands 438 and 440, and bands 446-454, the images and volumes are easily reviewed and capable of being further manipulated by software in computer 130.

Since electrophoresis gel sample 402 may be a result of only one of several experiments that are carried out over time, e.g., identical experiments are often performed to gather statistical significance, it is important to be able to normalize one experimental electrophoresis gel sample to other subsequent experimental electrophoresis gel samples carried out over time. By way of example, in a second experiment, a second electrophoresis gel sample is prepared as previously described. The second electrophoresis gel sample is analyzed and evaluated as previously described with luminescent standard 204, thereby generating pixel-volumes, V_{FS2} and V_{S2}, respectively.

Since the fluorescence of luminescent standard 204 does not appreciably change over time for a given amount of input light, a relationship is made between the first pixel-volume of luminescent standard 204 and the second second-pixel-volume of luminescent standard 204. By making this relationship, a correction factor is generated, whereby experiments and data can be normalized across numerous experiments and time. If the luminescence response curve of the sample representing an area or a spot being normalized is linear or approximating linear, then the following equation provides a mathematical representation for calculating and using the correction factor:

$$\frac{{V}_{FS 1}}{{V}_{FS 2}} ( {V}_{S 2} ) = {V}_{NS}$$

The correction factor is calculated by dividing the original pixel-volume from luminescent standard 204 (V_{FS1}) by a subsequent reading of luminescent standard 204 (V_{FS2}) while another sample or other samples V_{S2} are read at that same time as the subsequent reading of luminescent standard 204 (V_{FS2}). Once the correction factor has been calculated, normalization of other luminescent samples (V_{S2}) such as band 446 can be achieved by multiplying the correction factor and the particular sample together to yield a normalized sample value (V_{NS}), as shown above.

Additionally, variation due to day-to-day variability of equipment and environmental factors play an important part in the over all variability of the data and since this variability can confound and confuse results taken over time, using this embodiment of the invention, wrings out those variables so that a more accurate and repeatable results can be realized.

It should be understood that by using an embodiment of the present invention, normalizing and/or comparing one band to other bands can also be accomplished in a similar method as described above. Additionally, the normalizing and/or comparing can be achieved in a single sample or across many samples.

FIG. 6 is a greatly simplified illustration of a micro-well plate 600 having a plurality of micro-wells 602. The plurality of micro-wells 602 are cavities set into micro-well plate 600 and can be any suitable size and number. Typically, the plurality of micro-wells 602 can be used to do a wide variety of assays and chemistries to obtain certain results. By way of example only, in a typical experimental design, a certain chemical is chemically tagged with a luminescent marker. Depending upon the experimental design, the luminescent marker may increase or decrease its presence due to the experimental conditions and be distributed across the plurality of micro-wells 602. Thus, when micro-well plate 600 is exposed to light 604, certain micro-wells of the plurality of micro-wells 602 fluoresce at differing intensities indicating differing amounts and presence of the luminescent marker.

As shown in FIG. 6, luminescent standards 608, 610, and 612 are present or closely associated with micro-well plate 600. It should be understood that while luminescent standards 608, 610, and 612 are shown, in some instances, a single calibration standard can be used, as well as multiple calibrations standards. Calibration standards 608, 610, and 612 are made of the same luminescent material as previously discussed in FIG. 2. While in some instances calibration standards 608, 610, and 612 may have the same amount of fluorescence for a given amount and wavelength of light, calibration standards 608, 610, and 612 can also be arranged to have different amounts of fluorescence. The different amounts of fluorescence provide for an internal control of luminescent standards and allow for further calibration and normalize the plurality of mini-wells 602. Any suitable configuration of luminescent standards 608, 610, and 612 can be used depending upon the specific application. For example, luminescent standards 608, 610, and 612 can be integrated directly into micro-well plate 600, a stand alone calibration device, a detachably attachable device separated and attached along dotted line 614, or the like.

Calculation of the correction factor for calibration and normalization of micro-wells is accomplished as described in FIG. 4. However, with this embodiment, the plurality of micro-wells 602 would substitute for the plurality of bands 446-454 and luminescent standards would substitute for luminescent standards 204-208.

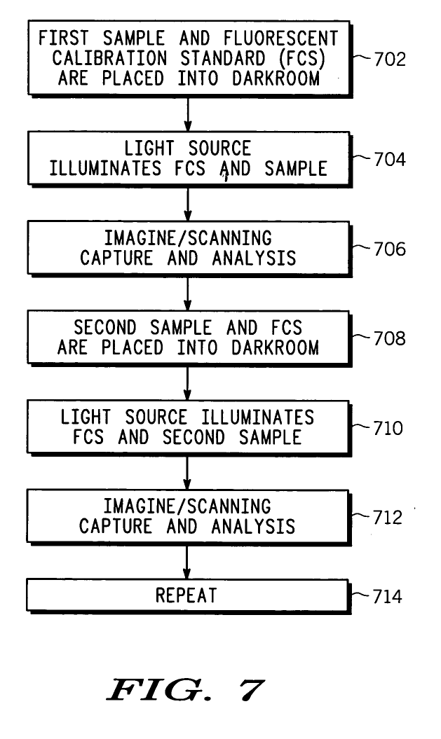

FIG. 7 is a diagrammatic illustration of a process flow chart 600 showing a method for calibrating and normalizing optical data from run to run over time. Typically, optical reading system 100 is turned on and prepared for capture and analysis of optical data. This preparation may involve launching imaging and acquisition software. As shown in box 702, in accordance with one embodiment of the invention and using luminescent standard 204 and electrophoresis gel sample 402 as an example, the process flow begins by placing luminescent calibration device 200 and electrophoresis gel sample 402 into dark room enclosure 102. However, it should be understood that any experimental luminescent sample can be calibrated and normalized with use of an appropriate luminescent standard in accordance with the invention and as described herein. Typically, luminescent calibration device 200 and luminescent gel 402 are placed within the optical field of image device 118.

As shown in box 704, a light source, typically an ultra violet light source is used to illuminate luminescent standard 204 and electrophoresis sample 402. The light is absorbed by luminescent standard 204 and by certain parts of electrophoresis gel sample 502 which causes luminescent standard 204 and the certain portions of electrophoresis gel 502 to fluoresce. The certain portions of the electrophoresis gel 402 fluoresce as in bands 446-454.

As shown in box 706, with luminescent standard 204 and electrophoresis sample 402 fluorescing, image device 118 takes an image of luminescent standard 204 and electrophoresis sample 402 and converts the images to electrical signals. The electrical signals are sent via cable 127 to computer 130. The converted optical images are stored in computer 130 and are capable of being manipulated by the software. The software identifies and resolves the plurality of columns 406 with the plurality of bands 438 and 440, bands 446-454, and luminescent standard 204.

After identification and resolution, the software calculates the individual pixel-volume of the plurality of bands 438 and 440, bands 446-454, and for luminescent standard 204. For the sake of clarity, on band 446 and luminescent standard 204 will be discussed in detail where necessary. The software then stores and labels the pixel-volumes for luminescent standard 204 and band 446 as V_{FS1} and V_{S1} in computer 130.

As shown in box 708, luminescent standard 204 and a second electrophoresis sample are then placed into dark room enclosure 102 within the optical field of imaging device 118 at some later time. As previously stated, optical reading system 100 is turned on and prepared for capture and analysis of optical data. This preparation may involve launching imaging and acquisition software. The process flow begins by placing luminescent calibration device 200 and the second electrophoresis gel sample into dark room enclosure 102.

As shown in box 710, a light source, typically an ultra violet light source is used to illuminate luminescent standard 204 and the second electrophoresis sample. The light is absorbed by luminescent standard 204 and by certain portions of the second electrophoresis gel sample, which causes luminescent standard 204 and the certain portions of the second electrophoresis gel sample to fluoresce.

As shown in box 712, with luminescent standard 204 and the second electrophoresis sample fluorescing, image device 118 takes an image of luminescent standard 204 and the second electrophoresis sample and converts the images to electrical signals. The electrical signals are sent via cable 127 to computer 130. The converted optical images are stored in computer 130 and are capable of being manipulated by the software. The software identifies and resolves the second plurality of columns with their associated bands and luminescent standard 204.

After identification, the software calculates individual volume of bands 446-454 and luminescent standard 204. As previously described in FIG. 4 a correction factor is calculated and then used to normalized bands 446-454. Thus the bands from the second electrophoresis gel sample are normalized to electrophoresis gel sample 402. This normalization allows results to be correlated and compared without the day-to-day variability that is inherent in non-normalized data. The results are more accurate, precise, and repeatable.

As shown in box 714, the normalization process can be repeated at any time, thereby adding flexibility without degrading experimental accuracy and repeatability.

### EXAMPLES

The following specific examples are meant to illustrate and not limit the scope of the invention. The following examples were performed with an equipment set including: AutoChemi™ Bioimaging System manufactured by UVP Inc., FirstLight uniform UV Illuminator manufactured by UVP Inc., a 12-bit camera (model C8484-03G) manufactured by Hamamatusu Phontonics, a lens manufactured by Computar Corp., Polyacrylamide gels manufactured by Bio-Rad, a fluorescent stain Sypro Ruby manufactured by Molecular Probes, calculation software distributed by UVP Inc.

As shown in FIGS. 4 and 5, the plurality of bands 438, 440, 442, 444, 524, and 526 are known molecular weight molecules that separate in accordance to their molecular weight. Bands 446-454, 456-464, and 526-534 belong to Bovine Serum Abumin with bands 446, 456, and 526 having 4.0 micrograms/milliliter; bands 448, 458, and 528 having 3.0 micrograms/milliliter; bands 450, 460, and 530 having 2.0 micrograms/milliliter; bands 452, 462, and 532 having 1.0 micrograms/milliliter, and bands 454, 464, and 534 having 0.5 microgram/milliliter.

In these experiments, “mean gray levels” (MGL) are used to represent the luminescence of bodies in consideration.

### Example 1

Example 1 demonstrates that there is system variation over time. In this experiment, luminescent standard 204 and electrophoreses gel 402 are placed into darkroom enclosure 102 and processed as described in FIG. 4 to generate an image and MGL values. (The figure also shows a separate electrophoresis gel 404. The use of this gel is made in next example #2.) After a period of time, electrophoresis gel 402 and luminescent standard 204 are reprocessed as previously described in FIG. 4 and is now shown in FIG. 5 as electrophoresis gel 502.

For the sake of clarity and simplicity, data from luminescent standard 204 and bands 446 and 526 will be used. The luminescent standard 204 and electrophoresis gel was removed for an X amount of time. The same luminescent standard 204 and same electrophoresis gel (shown as electrophoresis gel 502 on FIG. 5) was put back in the darkroom enclosure 102 and processed a second time.

The MGL values of luminescent standard 204 and corresponding bands were compared as shown in Table 1.

TABLE 1

| | FIG. 4 | | FIG. 5 | |
|---|---|---|---|---|
| | FRS (#204) | Band (#446) | FRS (#204) | Band (#526) |
| MGL | 2038.1 | 2399.6 | 1434.7 | 1864 |
| Area | 1867 | 231 | 1875 | 219 |
| (Pixels) | | | | |

The MGL values of luminescent standard 204 and bands 446 and 526 produce different values when the same materials are imaged at different times. Additionally, this data can be turned into ratios as shown below.
Ratio of FRSs (FIG. 4/FIG. 5)=2038.13/1434.74=1.4
Ratio of Bands (446/526)=2399.6/1864=1.3

As can be seen from Table 1 and the ratios above, MGL values can shift significantly over time. Moreover, the MGL values and the ratios shift proportionally across corresponding standards and bands. This shift in values can cause errors in interpreting data if not considered and normalized.

### Example 2

Example 2 demonstrates the normalization of two different electrophoresis gels 502 and 404. In this example, electrophoresis gel 404 has been processed in the same manner as electrophoresis gel 402 in FIG. 4. MGL values for luminescent standard 204 and bands 446 and 448 have been taken and stored in the memory of computer 130. The data from the luminescent standard 204 in FIG. 4 is identified as (FRS#1). In another experiment accomplished at a later time, electrophoresis gel 502 is generated. Electrophoresis gel 502 and luminescent standard 204 are placed into darkroom enclosure 102 imaged and processed so as to generate data.

For the sake of simplicity and clarity, the data from luminescent standard 204 taken with electrophoresis gel 502 in FIG. 5 will be identified as (FRS#2) and data from bands 526 and 528 will be used.

The MGL values recorded as described above are compared as shown in Table 2.

TABLE 2

| | FRS | Band | Band | FRS | Band | Band |
|---|---|---|---|---|---|---|
| | (204) | (446) | (448) | (204) | (526) | (528) |
| MGL | 2038.1 | 1805.5 | 1739.5 | 1434.8 | 1864 | 1788.2 |
| Area | 1867 | 196 | 228 | 1875 | 219 | 225 |
| (Pixels) | | | | | | |

Normalization of band 526 to relate it to the first experiment shown in electrophoresis gel 402 is accomplished by using the following formula:

$$Normalized value of band of band 526 = ( \frac{FRS \#1}{FRS \#2} ) band 526$$

Where FRS#1 is the MGL value of luminescent standard 204 in FIG. 4, where FRS#2 is the MGL value of luminescent standard 204 in FIG. 5, and where “band 526” is the MGL value of band 526 of electrophoresis gel 502. In this particular example, band 446 should be fluorescing 46.5% higher then what is actually being observed, in order for band 446 to be considered equal fluorescence to band 526. It should be further understood that in the present invention, flexibility exists that allows the user to normalize any MGL value ieth being analyzed or strored in memory. This allows the optical reading system 100, as a whole, and data analysis system 108 to be extremely flexible and to maximize data analysis. Thus, it should be understood that normalization of band 446 from gel 402 (e.g. 446) could be normalized in the following manner.

$$Normalized value of band of band 446 = ( \frac{FRS \#2}{FRS \#1} ) band 446$$

For the basic normalization process used in this example to hold true, the response curve of intensity of wavelengths emitted with respect to intensity of excitation/incident light must be largely linear for the luminescent body being normalized. Such a curve is already known to be linear for luminescent standard 204 being used here. However, to calibrate luminescent samples having a high dynamic range, the response should be modeled as curvilinear and a curvilinear calibration method may be required, wherein the following equation can be used:

$$F \{ ( \frac{{V}_{FS 1}}{{V}_{FS 2}} ) {F}^{- 1} ( V ( S 2 ) ) \} = V ( NS )$$

where F(x) is the curvilinear response curve of the luminescent sample, where V_{FS1} is the value for the first luminescent standard, where V_{FS2} is the value of the second luminescent standard, where V_{S2} is the value of the second luminescent sample, and where V_{NS} is the normalized value of the second luminescent sample.

Using the normalization process described, luminescence from the sample in question can be normalized relative to:
A) luminescence from same instance of the sample at a different time-point. Example-1 illustrates this fact for a specific type of experiment;
B) luminescence from another sample of the same type in the same quantity, imaged under same conditions at a different time-point. Example-2 illustrates this fact for a specific type of experiment; and
C) luminescence from another sample of the same type, in a different quantity, imaged under same conditions at a different time-point. In this case, the normalized value can be understood as absolute corrected value of the second sample.

In the foregoing specification and examples, the invention has been described with reference to specific embodiments. However, one of ordinary skill in the art appreciates that various modification and changes can be made without departing from the scope of the invention as set forth in the claims below. Accordingly, the specification and figures are to be regarded in an illustrative rather than a restrictive sense and all such modifications are intended to be included within the scope of the invention.

Benefits, other advantages, and solutions to problems have been described above with regard to specific embodiments. However, the benefits, advantages solutions to problems, and any element(s) that may cause any benefit, advantage, or solution to occur to become more pronounced are not to be construed as a critical, required, or essential feature or element of any or all claims.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A luminescent calibration device comprising:
a housing having a first surface, the housing having a length, a width, and thickness; and;
a luminescent standard positioned on the housing, the luminescent standard having a size.

2. The luminescent calibration device as claimed in claim 1 wherein the luminescent standard is made of a phosphor.

3. The luminescent calibration device as claimed in claim 1 wherein the luminescent standard is adhered to the housing.

4. The luminescent calibration device as claimed in claim 1 wherein the luminescent standard is held by a portion of the housing.

5. The luminescent calibration device as claimed in claim 1 further including:
a window positioned above the luminescent standard, the window exposes at least a portion of the luminescent standard.

6. The luminescent calibration device as claimed in claim 1, wherein the window is a plurality of windows with a space therebetween and wherein the luminescent standard is a plurality of luminescent standards, the plurality of window expose portions of the plurality of luminescent standards.

7. The luminescent calibration device as claimed in claim 6, wherein the space between the luminescent standards is greater then a distance that allows cross-talk between the luminescent standards.

8. The luminescent calibration device as claimed in claim 1 wherein the luminescent standard is opaque.

9. The luminescent calibration device as claimed in claim 1 wherein the luminescent standard is translucent.

10. The luminescent calibration device as claimed in claim 1 wherein, the length ranges from 1.0 centimeters to 40.0 centimeters.

11. The luminescent calibration device as claimed in claim 10 wherein, the length ranges from 2.5 centimeters to 10.0 centimeters.

12. The luminescent calibration device as claimed in claim 1 wherein, the size of luminescent standard ranges from 30.0 nanometers to 30.0 centimeters.

13. A luminescent calibration device comprising:
a housing having a first surface, a second surface and a side, the first surface having a length and a width, the side having a height;
a window having a depth disposed through the base substantially apart from the side of the base; and
a fluorescent standard positioned with at least a portion of the luminescent standard being exposed through the window.

14. The luminescent calibration device as claimed in claim 13 wherein, the opening is a plurality of openings with at least one fluorescent reference standard positioned therein, the plurality of openings spaced apart from each opening with a distance and the plurality of openings spaced apart from the side of the base.

15. The luminescent calibration device as claimed in claim 14 wherein the distance between the plurality of openings prevents cross-talk.

16. The luminescent calibration device as claimed in claim 13 wherein, the window further includes a filter.

17. The luminescent calibration device as claimed in claim 13 wherein, the size of the luminescent standard ranges from 30.0 nanometers to 30.0 centimeters.

18. The luminescent calibration device as claimed in claim 13 wherein, the luminescent standard is opaque.

19. The luminescent calibration device as claimed in claim 13 wherein, the luminescent standard is translucent.

20. A method for normalizing variability in an optical system comprising the steps of:
providing an luminescent standard;
providing a first luminescent sample;
illuminating the luminescent standard and the first luminescent sample with a quantity of light, the luminescent standard and the first luminescent sample luminesce a portion of the light;
collecting at least a portion of the light from the luminescent standard and from the first luminescent sample, the at least a portion of the light from the luminescent standard having a first value and the at least a portion of the light from the first luminescent sample having a second value;
storing the first value and the second value;
providing a second luminescent sample;
illuminating the luminescent standard and the second luminescent sample with a light, the luminescent standard and the second luminescent sample emit a portion of light;
collecting at least a portion of the light from the luminescent standard and from the first luminescent sample, the at least a portion of the collected light from the luminescent standard having a third value and the at least a portion of the collected light from the second luminescent sample having a fourth value; and
normalizing the fourth value by using the following equation:
$$\frac{{V}_{FS 1}}{{V}_{FS 2}} ( {V}_{S 2} ) ≡ {V}_{NS}$$
where V_{FS1} is the first value of the luminescent standard, where V_{FS2} is the third value of the luminescent standard, where V_{S2} is the fourth value of the second luminescent sample, and where V_{NS} is a normalized value of second luminescent sample.

21. The method for normalizing variability in an optical system as claimed in claim 20 wherein, the step of illuminating the luminescent standard and the luminescent sample the light has a wavelength from 172 to 400 nanometers.

22. The method for normalizing variability in an optical system as claimed in claim 20 wherein, the step of illuminating the luminescent standard and the luminescent sample the light has a wavelength from 300 to 750 nanometers.

23. The method for normalizing variability in an optical system as claimed in claim 20 wherein, the step of collecting at least a portion of the light from the luminescent standard and the luminescent sample, the collection is achieved by a CCD camera.

24. The method for normalizing variability in an optical system as claimed in claim 20 wherein, the step of collecting at least a portion of the light from the luminescent standard and the luminescent sample, the collection is achieved by semiconductor imaging device.

25. The method for normalizing variability in an optical system as claimed in claim 20 wherein, the step of collecting at least a portion of the light from the luminescent standard and the luminescent sample, the values of the luminescent standard and the luminescent sample are converted into pixels.

26. The method for normalizing variability in an optical system as claimed in 24 wherein, the step of collecting at least a portion of the light from the luminescent standard and the luminescent sample, the pixels have an associated grey scale.

27. The method for normalizing variability in an optical system as claimed in claim 20 wherein, the step of providing a luminescent standard, the luminescent standard is made of a non-photo bleaching ceramic.

28. A method for calibrating a luminescent sample in a light detection system using a luminescent calibration device comprising the step of:
illuminating a first luminescent calibration standard and a first target sample with ultraviolet light, the first luminescent calibration standard fluoresces with a first quantity of photons and the first target sample fluoresces with a second quantity of photons;
imaging the first fluorescent calibration standard and the first target sample with an imaging device;
generating gray values from the first fluorescent calibration standard and the first target sample;
processing the gray values from the first fluorescent calibration standard and storing the gray values in a first location;
processing the gray values from the first target sample and storing the gray values in a second location;
illuminating the first fluorescent calibration standard and a second target sample with ultraviolet light, the first fluorescent calibration standard fluoresces quantity of photons and the second target sample fluoresces with a second quantity of photons;
imaging the first fluorescent calibration standard and the second target sample with the imaging device;
generating gray values from the first fluorescent calibration standard and the second target sample;
processing the gray values from the first fluorescent calibration and storing the gray values in a third location;
processing the gray values from the second target sample and storing the gray values from the second target sample in a fourth location; and
generating a correction factor to adjust gray values of the second target sample by dividing the gray values in the first location by the gray values of the third location.

29. A computer readable medium storing a computer program comprising:
computer readable code for generating luminescent pixel values from the first luminescent calibration standard and the first target sample;
computer readable code for storing the pixel values from the first luminescent calibration standard in a first location and storing the pixel values from the first target sample in a second location;
computer readable code for generating pixel values from the first luminescent calibration standard and a second target sample;
computer readable code for storing the first luminescent calibration standard in a third location and storing the pixel values from the second target sample in a fourth location; and
computer readable code for generating a correction factor to normalize pixel values of the second target sample, wherein the correction factor is generated by calculating a ratio of processed pixel values of the first location and the third location and multiplying the ratio by the pixel values of the second target sample to normalize the pixel values of the second target sample.

30. A method for normalizing variability in an optical system comprising the steps of:
providing a luminescent standard;
providing a first luminescent sample;
illuminating the luminescent standard and the first luminescent sample with a quantity of light, the luminescent standard and the first luminescent sample luminesces a portion of the light;
collecting at least a portion of the light from the luminescent standard and from the first luminescent sample, the at least a portion of the light from the luminescent standard having a first value and the at least a portion of the light from the first luminescent sample having a second value;
storing the first value and the second value;
providing a second luminescent sample;
illuminating the luminescent standard and the second luminescent sample with a light, the luminescent standard and the second luminescent sample luminesces a portion of light;
collecting at least a portion of the light from the luminescent standard and from the second luminescent sample, the at least a portion of the collected light from the luminescent standard having a third value and the at least a portion of the collected light from the second luminescent sample having a fourth value; and
normalizing the fourth value by using the following-equation:
$$F \{ ( \frac{{V}_{FS 1}}{{V}_{FS 2}} ) {F}^{- 1} ( V ( S 2 ) ) \} = V ( NS )$$
where V_{FS1} is the value of the mathematical representation of the area of the luminescent standard, where V_{FS2} is the third value of the mathematical representation of the area of the luminescent standard, where V_{S2} is the fourth value of the mathematical representation of the second luminescent sample, and where V_{NS} is the normalized value of second luminescent sample.
